(19) United States
(12) Patent Application Publication
(10) Pub. No.: US 2019/0017459 A1
(43) Pub. Date: Jan. 17, 2019

(54) METHOD FOR STARTING AN INTERNAL COMBUSTION ENGINE

(71) Applicant: MAN Truck & Bus AG, Munchen (DE)

(72) Inventor: Werner Kübler, Kammerstein (DE)

(21) Appl. No.: 16/016,210

(22) Filed: Jun. 22, 2018

(30) Foreign Application Priority Data
Jul. 12, 2017 (DE) 102017115596.1

(51) Int. Cl. F02D 41/30; F01L 13/08; F02D 33/00; F02N 19/00

(52) U.S. Cl. CPC F02D 41/3005; F01L 13/08; F02D 33/006; F02N 2200/022; F01L 2201/00; F02D 2200/101; F02N 19/004

(57) ABSTRACT

A method for starting an internal combustion engine, having which has at least one cylinder, a controllable starter and a controllable fuel injection device, at least one cylinder, in particular every cylinder, of the internal combustion engine being assigned at least one decompression valve for reducing the compression which takes place during the operation of the internal combustion engine in the case of a compression stroke. A defined starting rotational speed is predetermined in the control unit, that, in the case of a controlled activation of the starter, the at least one decompression valve is opened in an automatically controlled manner by means of a control unit, and that the control unit detects the current rotational speed of the internal combustion engine and, when the defined starting rotational speed is reached, closes the at least one decompression valve and activates the fuel injection device.

### BACKGROUND

The disclosure relates to a method for starting an internal combustion engine, an apparatus for carrying out the method, and a vehicle for carrying out the method and/or having the apparatus.

A generally known internal combustion engine, in particular a diesel internal combustion engine in a commercial vehicle or in a stationary system, has at least one cylinder, usually a plurality of cylinders, a controllable starter, a controllable fuel injection device and a control unit.

In order to start the internal combustion engine, a starting operating element, for example an ignition key, is actuated by the driver of a commercial vehicle, as a result of which the control unit activates the starter and the fuel injection device. By way of the activation of the starter, the internal combustion engine is driven at an increasing engine rotational speed, and the internal combustion engine starts.

It is a disadvantage in the case of this generally known starting operation that the starter has to overcome the compression in the compression stroke of each cylinder up to the engine start by way of a relatively high starter torque, with the result that the starter has to be dimensioned for a correspondingly high performance. A further disadvantage consists in that unburnt fuel passes into the exhaust gas system as a result of the simultaneous activation of the fuel injection device during the starting operation, and leads to unfavourably high environmentally harmful emissions.

Furthermore, it is generally known to equip an internal combustion engine, in particular a stationary internal combustion engine, with a decompression lever, by way of which inlet and/or outlet valves can be opened mechanically during the starting operation in order to suppress a compression. When the engine rotational speed rises after actuation of a starter and a starting person assumes that a suitable starting rotational speed has been reached, the decompression lever is flipped over, as a result of which the valves gain their operational function and the internal combustion engine starts. This measure for a relatively low starter torque can clearly be carried out only if there is a decompression lever on an internal combustion engine and it is directly accessible, which is usually not the case, in particular, in vehicles. In addition, the fuel injection device is also already activated here at the beginning of the starting operation, with the result that high environmentally harmful emissions are also produced here during the starting operation.

### SUMMARY

It is an object of the disclosure, in contrast with this, to propose a method for starting an internal combustion engine and an apparatus for carrying out the method, in the case of which a required starter torque and, in addition, environmentally harmful emissions can be reduced reliably and effectively.

The said object is achieved by way of the features of the independent patent claims. Preferred developments are disclosed in the subclaims.

According to one aspect of the disclosure, a method for starting an internal combustion engine is proposed, the internal combustion engine having at least one cylinder, a controllable starter and a controllable fuel injection device, at least one cylinder, in particular every cylinder, of the internal combustion engine being assigned at least one decompression valve for reducing the compression which takes place during operation of the internal combustion engine in the case of a compression stroke. According to the disclosure, a defined starting rotational speed is predetermined in the control unit. In addition, in the case of a controlled activation of the starter, in particular at the same time, the at least one decompression valve is also opened in an automatically controlled manner by means of a control unit, the fuel injection device not yet being activated here.

As a result of the activation of the starter, the internal combustion engine revs up and the engine rotational speed rises.

The control unit detects the current, rising rotational speed of the internal combustion engine and closes the at least one decompression valve when the defined starting rotational speed is reached. In addition, in particular after the closure of the at least one decompression valve, the fuel injection device is then activated, with the result that the internal combustion engine reacts immediately and is started.

The starting method according to the disclosure proceeds automatically after actuation of a starting operating element. Since no counterforce which is built up as a result of compression has to be overcome by the starter during the starting operation, a comparatively small starter torque is required for the starting operation. Therefore, the starter can advantageously be dimensioned with a relatively low performance and possibly a small overall volume. The required starting energy is also advantageously comparatively low. An electric starter is preferably used; in principle, the method can also be carried out by way of other starter embodiments, for example by way of a pneumatic or hydraulic starter.

Since the fuel injection device is activated by the control unit only after the predetermined starting rotational speed is reached, advantageously no environmentally harmful emissions are produced during the starting operation, with the result that the overall emissions of the internal combustion engine are advantageously reduced.

The above-described method is suitable, in particular, for multiple-cylinder diesel internal combustion engines which are installed, in particular, as a drive engine in commercial vehicles.

Rotational speeds between 100 rpm and 180 rpm are preferably suitable as a defined starting rotational speed which is predetermined in the control unit. A starting rotational speed can possibly be adapted automatically in the control unit in a variably defined manner to different, detected boundary conditions, in particular to different environmental conditions.

An additional controllable valve is preferably proposed as a decompression valve for the respective cylinder, in addition to the existing inlet and outlet valves. In principle, however, an inlet and/or outlet valve which can be opened by way of the control unit can also be used in a further function as a decompression valve in accordance with the method. An additional decompression valve is preferably to be configured as an electrically controllable solenoid valve.

The starter and the fuel injection device can preferably likewise be controlled by means of the control unit, in order to realize a simple construction. The control unit for the starting operation is preferably integrated at least partially into an engine control unit, with the result that no additional costs are then produced in terms of control technology for the method according to the disclosure.

Since only a comparatively substantially lower starter torque is required in the case of the starting method according to the disclosure, an electric starter which is customary nowadays in internal combustion engines can possibly be dispensed with, and a starter generator, preferably a starter generator which can be operated using 48 V, can be used. The starter generator should then be dimensioned in such a way that, during normal operation of the internal combustion engine, it provides the required electric power output for at least one electric auxiliary consumer or auxiliary unit which is assigned to the engine, such as an electric water pump, for example. As a result, the at least one auxiliary unit which can be driven electrically can be supplied with sufficient electric drive energy by the starter generator.

The starter generator is further preferably integrated into the gear train of the internal combustion engine, in particular with a high transmission ratio, as a result of which a drive belt for a belt drive can possibly be dispensed with. Specifically, the starter generator can then have a gearwheel as a drive element, which gearwheel is in tooth engagement with a gearwheel of the gear train.

In one development of the method according to the disclosure, in the case of an internal combustion engine having a cylinder switch-off means for at least one cylinder, which cylinder switch-off means can be controlled in normal operation, it is proposed to use the associated decompression valve for a further function: in normal operation, in the case of a switched-off combustion function, the decompression valve is to be capable of being opened in a controlled manner, with the result that the associated cylinder/piston unit operates as a pressure pump. As a result, compressed air for devices which are operated by compressed air can be delivered. An apparatus for delivering compressed air by means of a cylinder/piston unit and an actuable removal valve is already known from AT 51 41 27 B1 (2015 Feb. 15).

The at least one decompression valve is further preferably assigned to a cylinder head of the internal combustion engine, in order to realize a simple and effective construction.

In order to achieve the abovementioned object, furthermore, an apparatus is claimed, having an internal combustion engine which has at least one cylinder, a controllable starter and a controllable fuel injection device, at least one cylinder, in particular every cylinder, being assigned at least one decompression valve for reducing the compression which takes place during operation of the internal combustion engine in the case of a compression stroke. It is provided according to the disclosure that a defined starting rotational speed is predetermined in the control unit, that, in the case of a controlled activation of the starter, the at least one decompression valve is opened in an automatically controlled manner by means of a control unit, and that the control unit detects the current rotational speed of the internal combustion engine and, when the defined starting rotational speed is reached, closes the at least one decompression valve and activates the fuel injection device.

Furthermore, a vehicle, in particular a commercial vehicle, for carrying out the method according to the disclosure and/or having the apparatus according to the disclosure is also claimed.

The advantages which result from the apparatus according to the disclosure and the vehicle according to the disclosure are identical to the advantages of the method according to the disclosure which have already been acknowledged, with the result that said advantages are not repeated at this point.

### BRIEF DESCRIPTION OF THE DRAWING

FIG. 1 is a flow chart depicting the method of the present disclosure.

### DETAILED DESCRIPTION

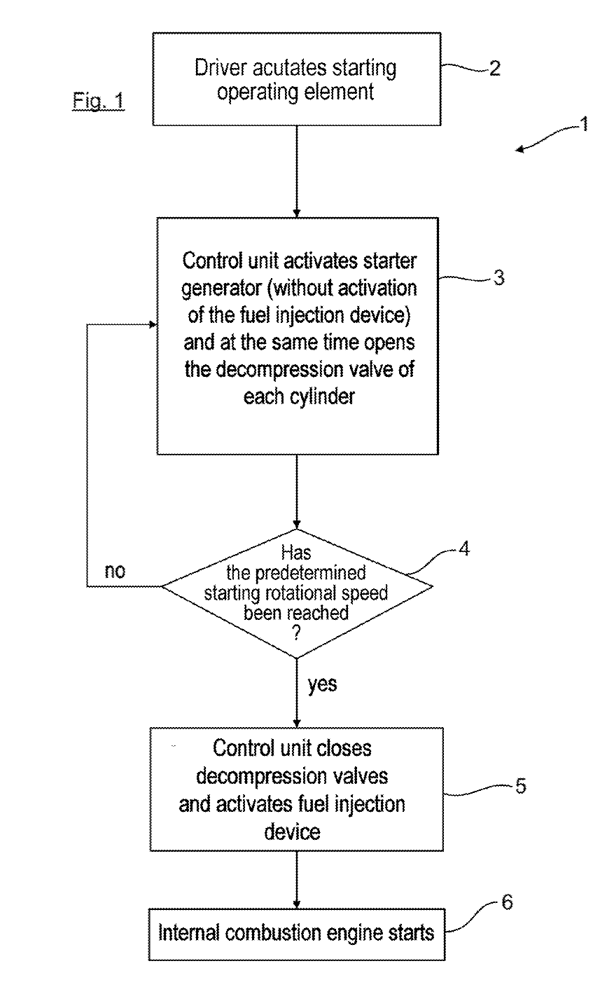

The disclosure will be described in further detail by way of example using FIG. 1.

The single FIGURE shows a flow chart 1 of the starting method according to the disclosure, as is realized, for example, for a multiple-cylinder diesel internal combustion engine in a commercial vehicle.

In accordance with status rectangle 2, a driver in the driver's cab actuates a starting operating element for engine starting, for example by way of an ignition key.

As a result, in accordance with status rectangle 3, a control unit is actuated which activates a starter generator for an engine drive. At the same time, the decompression valves of the individual cylinders are opened. In contrast, the fuel injection device is not yet activated.

In the decision diamond 4, a check is made by the control unit as to whether the rotational speed which rises by way of activation of the starter generator has reached a starting rotational speed which is predetermined in the control unit.

If this is the case, in accordance with status rectangle 5, the control unit closes the decompression valves and activates the fuel injection device, with the result that the internal combustion engine reacts and starts in accordance with status rectangle 6, after which the starter function of the starter generator is switched off and a switchover is carried out to the generator function.

### LIST OF DESIGNATIONS

1 Flow chart
2 Status rectangle
3 Status rectangle
4 Decision diamond
5 Status rectangle
6 Status rectangle

1. A method for starting an internal combustion engine, which has at least one cylinder, a controllable starter and a controllable fuel injection device, at least one cylinder, in particular every cylinder, of the internal combustion engine being assigned at least one decompression valve for reducing the compression which takes place during the operation of the internal combustion engine in the case of a compression stroke, the method comprising
predetermining in a control unit a defined starting rotational speed;
automatically opening the at least one decompression valve in an controlled manner by means of the control unit, during a controlled activation of the starter; and
detecting the current rotational speed of the internal combustion engine and, when the defined starting rotational speed is reached, closing the at least one decompression valve and activating the fuel injection device. in that the control unit

2. The method according to claim 1, characterized in that the internal combustion engine is a multiple-cylinder diesel internal combustion engine.

3. The method according to claim 2, wherein the multiple-cylinder diesel internal combustion engine is a drive engine of a commercial vehicle.

4. The method according to claim 1, wherein the starting rotational speed lies in a rotational speed range of from 100 rpm to 180 rpm.

5. The method according to claim 1, wherein the at least one decompression valve is configured as a solenoid valve and is controlled electrically.

6. The method according to claim 1, wherein the starter and the fuel injection device can likewise be controlled by means of the control unit.

7. The method of according to claim 6, wherein the control unit is integrated at least partially into an engine control unit.

8. The method according to claim 1, wherein the starter is configured as a starter generator.

9. The method according to claim 8, wherein the starter generator can be operated using 48 Volts.

10. The method according to claim 9, wherein, at least one electrically drivable auxiliary unit of the internal combustion engine is supplied with electric drive energy by the starter generator.

11. The method according to claim 10, wherein the at least one electrically drivable auxiliary unit is an electrically drivable water pump,

12. The method according to claim 8, wherein the starter generator is integrated into the gear train of the internal combustion engine.

13. The method according to claim 12, wherein the starter generator is integrated into a gear train with a high transmission ratio.

14. The method according to claim 13, wherein the starter generator has a gearwheel as drive element which is in tooth engagement with a gearwheel of the gear train.

15. The method according to claim 1, wherein during the operation of an internal combustion engine with a controllable cylinder switch-off means, the decompression valve of at least one switched off cylinder is opened in a controlled manner in a further function for pressure generation for a pneumatic component which is connected to the decompression valve.

16. The method according to claim 1, wherein the at least one decompression valve is assigned to a cylinder head of the internal combustion engine.

17. An apparatus for starting an internal combustion engine comprising:
an internal combustion engine including at least one cylinder;
a controllable starter and a controllable fuel injection device in communication with the at least one cylinder;
a decompression valve assigned to the at the least one cylinder, the decompression valve reducing the compression which takes place during the operation of the internal combustion engine in the case of a compression stroke; and
a control unit defines a predetermined rotational speed, wherein upon a controlled activation of the starter, the at least one decompression valve is opened in an automatically controlled manner by means of the control unit, and wherein the control unit detects the current rotational speed of the internal combustion engine and, when the defined starting rotational speed is reached, closes the at least one decompression valve and activates the fuel injection device.

18. A vehicle, comprising:
an internal combustion engine including at least one cylinder;
a controllable starter and a controllable fuel injection device in communication with the at least one cylinder;
a decompression valve assigned to the at the least one cylinder, the decompression valve reducing the compression which takes place during the operation of the internal combustion engine in the case of a compression stroke; and
a control unit defines a predetermined rotational speed, wherein upon a controlled activation of the starter, the at least one decompression valve is opened in an automatically controlled manner by means of the control unit, and wherein the control unit detects the current rotational speed of the internal combustion engine and, when the defined starting rotational speed is reached, closes the at least one decompression valve and activates the fuel injection device.
